(19) United States
(12) Patent Application Publication
(10) Pub. No.: US 2026/0227502 A1
(43) Pub. Date: Aug. 6, 2026

(54) METHOD FOR DETECTING AN OBJECT AND ANGLE-RESOLVING FMCW RADAR SENSOR SYSTEM

(71) Applicant: Robert Bosch GmbH, Stuttgart (DE)

(72) Inventors: Benedikt Loesch, Stuttgart (DE); Steffen Bucher, Leonberg (DE)

(21) Appl. No.: 19/127,838

(22) PCT Filed: Dec. 20, 2023
(86) PCT No.: PCT/EP2023/086920

§ 371 Date: May 7, 2025

(30) Foreign Application Priority Data
Feb. 8, 2023 (DE) 10 2023 200 997.8

(51) Int. Cl. G01S 13/58; G01S 7/35; G01S 13/42; G01S 13/931

(52) U.S. Cl. CPC G01S 13/584; G01S 7/354; G01S 7/356; G01S 13/42; G01S 13/931

(57) ABSTRACT

A method for detecting an object using an angle-resolving FMCW radar sensor. An at least three-dimensional spectrum with a distance dimension, a Doppler dimension indicating the relative velocity of the objects, and an angular dimension is generated based on received signals from multiple receiving channels of the radar sensor. The radar sensor undersamples in the Doppler dimension and the spectrum is therefore incomplete and ambiguous. A frequency modulation scheme with a plurality of interleaved sequences of temporally equidistant frequency ramps is used to resolve the ambiguities and, for each of a plurality of velocity hypotheses, a velocity-dependent phase offset between the received signals obtained for the sequences is modeled based on known time offsets between the frequency ramps belonging to different sequences and compared with the measured phase offset. During the phase comparison, angle-dependent phase offsets of the different receiving channels are evaluated together with the velocity-dependent phase offsets.

### FIELD

The present invention relates to a method for detecting an object using an angle-resolving FMCW radar sensor, in which an at least three-dimensional spectrum with a distance dimension, a Doppler dimension indicating the relative velocity of the objects and an angular dimension is generated on the basis of received signals from multiple receiving channels of the radar sensor, wherein the radar sensor undersamples in the Doppler dimension and the spectrum in this dimension is therefore incomplete and ambiguous, and wherein a frequency modulation scheme with a plurality of interleaved sequences of temporally equidistant frequency ramps is used to resolve the ambiguities and, for each of a plurality of velocity hypotheses, a velocity-dependent phase offset between the received signals obtained for the different sequences is modeled on the basis of known time offsets between the frequency ramps belonging to different sequences and compared with the measured phase offset.

The present invention relates in particular to a method and a radar sensor system for motor vehicles.

### BACKGROUND INFORMATION

Radar sensors are often used for surroundings monitoring in driver assistance systems because they enable direct measurement of the distance (d), the relative velocity (v) and the azimuth and elevation angle (α, θ) of objects.

Some conventional radar sensors work with a sequence of identical, relatively short frequency ramps, so-called “rapid chirps”, which have a large frequency swing in relation to their duration and are therefore so steep that the distance-dependent component of the frequency shift dominates in the baseband signal, while the Doppler shift is sampled by the sequence of ramps. Therefore, in order to enable an unambiguous determination of the relative velocity within a desired measuring range of the relative velocity, a sufficiently high repetition rate of the short ramps is necessary. The time offset between successive short ramps has to in particular be less than half the period of the Doppler frequency. Such a short time offset places high demands on the analog hardware. Achieving a good signal-to-noise ratio therefore necessitates the presence of many such short ramps. This leads to a comparatively high memory requirement and computing effort for evaluating the data.

To continually improve the functionality of driver assistance systems and increase the penetration rate in the vehicles, ever more powerful sensors with a greater range are needed that should at the same time also be cost-efficient. To enable accurate velocity and distance estimation of radar objects with the lowest possible hardware and computing effort, the use of several successive sequences of frequency modulation ramps with a temporal spacing of the ramps, in which an undersampling of the Doppler shift occurs over the sequence of the ramps so that the obtained information about the relative velocity contains ambiguity, has been proposed.

Germany Patent Application No. DE 10 2014 212 280 A1 describes a method with temporally interleaved ramp sequences that allows an unambiguous velocity estimation by evaluating the relative phases between the same peak positions in the two-dimensional spectra after a two-dimensional Fast Fourier Transformation (2D FFT) of each ramp sequence and comparing them with a model relationship for the ambiguity hypotheses. The resolution of the ambiguities is referred to hereinafter as “velocity ambiguity resolution (VAR)”. In Germany Patent Application Nos. DE 10 2014 212 284 A1 and DE 10 2017 200 317 A1, the method was extended to include several transmitting antennas that are operated in time-division multiplexing or in code-division multiplexing with periodic codes via the chirps.

Due to the undersampling of the Doppler dimension, however, overlapping between targets with different relative velocities can occur. If these overlaps do not prevent the detection of the target signals, the targets can be separated using a method described in Germany Patent Application No. DE 10 2014 223 990 A1. However, this involves a large amount of computing effort. A target can moreover also be masked by a second target in an adjacent distance Doppler cell, so that detection is prevented.

Germany Patent Application No. DE 10 2021 213 495 describes a method that can increase the range or sensitivity of the radar sensor so that weaker targets can be detected earlier, and also avoid the negative effects of spectral overlapping of targets. The modulation sequences are thus already coherently summed using a “velocity beamformer” before detection. This enables the receive power to be increased for “desired” velocities and reduced for “undesired” velocities.

The above-described approaches do not evaluate velocity information and angle information together, so that the ability to separate multiple targets is determined by the ability to separate them individually in terms of velocity and angle.

Germany Patent Application Nos. DE 10 2020 202 498 A1, DE 10 2020 202 499 A1 and DE 10 2020 202 500 A1 describe methods for MIMO (multiple-input multiple-output) radar systems, in which high-resolution spectra are evaluated in a first detection stage, but which are ambiguous in both the Doppler dimension and the angular dimension. The spectra obtained for different ramp sequences and different combinations of transmitting and receiving antennas are non-coherently added, and object detection is carried out based on the thus formed sum spectrum. Ambiguity hypotheses are then tested for the objects found to resolve the ambiguities. After correction of the velocity- and angle-dependent phase shifts, the phase-corrected complex amplitudes of the detection are coherently added so that a lower-resolution but unambiguous spectrum is obtained in a second detection stage. Merging the results obtained in the two detection stages then makes it possible to determine the relative velocities and the azimuth and elevation angles of the detected objects unambiguously and with high resolution.

### SUMMARY

An object of the present invention is to further increase the sensitivity of the detection and to improve the robustness against multi-target scenarios.

This object may be achieved according to the present invention in that angle-dependent phase offsets of the different receiving channels are evaluated together with the velocity-dependent phase offsets during phase alignment and a complete and unambiguous spectrum is reconstructed and in that object detection is carried out on the basis of the reconstructed spectrum.

In the method according to an example embodiment of the present invention, the information in the large number of multidimensional spectra is used extensively to reconstruct an “ideal” spectrum that would be obtained in the given situation if the radar sensor did not undersample in the Doppler dimension or in the angular dimension. Since the actual object detection is only carried out on the basis of this reconstructed spectrum, which is both high-resolution and unambiguous, an improved object separability is achieved. The joint processing of velocity information and angle information moreover significantly reduces the likelihood of peak overlaps and masking of objects. Evaluating the information from a plurality of individual spectra also achieves increased sensitivity.

Advantageous example embodiments of the method of the present invention are disclosed herein.

A variety of methods can be used to reconstruct the unambiguous spectrum. One of these methods is merging the aforementioned VAR (velocity ambiguity resolution), i.e., the dissolution of velocity ambiguities, with the conventional methods for angle estimation (ANG) using a common single-target or multi-target model for velocity ambiguities and angle information.

In the case of a single-target model, such joint processing can be realized by coherent velocity and angular beamforming.

Angular beamforming as such is a conventional method in which the phases of the signals received in the different (real or virtual) receiving channels are corrected in such a way that the phase offsets that are dependent on the location angle and caused by the spatial offsets between the different transmitting and receiving antennas are compensated in such a way that the sensor is primarily sensitive to “beams” coming from a specific direction. In the case of velocity beamforming, the phase shifts from ramp to ramp within a ramp sequence that are dependent on the relative velocity are compensated in a similar way, so that the sensitivity for objects with a certain relative velocity is increased. In the case of coherent velocity and angular beamforming, the two phase corrections are combined with one another. This makes it possible to selectively increase the sensitivity for specific critical points in the multidimensional spectrum, so that overlaps close to one another can be better resolved. Conversely, signals from interfering objects such as guide posts on the side of the road can also be specifically suppressed.

Joint processing suppresses side lobes to a greater extent than would be the case with separate or sequential processing, so that the dynamic range for targets with a different velocity and a different angle can be increased and weaker targets can be detected as well. In addition to the simultaneous 2D (velocity and angle) evaluation, iterative approaches in which the estimates for the two dimensions (velocity and angle) are optimized alternately are possible for the joint processing as well.

F. Marvasti et al., “A Unified Approach to Sparse Signal Processing”, EURASIP Journal on Adv. in Sig. Proc., Volume 2012, No. 1, Feb. 2012, describes a sparse reconstruction algorithm that can be used as an alternative method for reconstructing the unambiguous spectrum.

Another alternative is the use of deep learning or artificial intelligence. In that case, a neural network is trained to reconstruct the respective unambiguous spectrum from the ambiguous spectra obtained by undersampling. The training data needed for the neural network can be compiled by acquiring one and the same surroundings with a radar sensor that is operating with undersampling, for instance, and also with a radar sensor that is operating without undersampling but otherwise has equivalent specifications. The training data can alternatively also be generated simulatively using suitable simulation methods (ray tracing, channel simulation, 1.

In principle, the method described here can be used to resolve ambiguities in the Doppler dimension and also ambiguities in the azimuth angle and/or elevation angle. However, the method is also advantageous for radar sensors that comprise a fully populated antenna array and therefore provide an unambiguous spectrum in the angular dimension.

The present invention also relates to a radar sensor system in which the method according to the present invention is implemented.

A radar sensor for motor vehicles typically comprises an integrated processor unit that handles the evaluation of the digital reception signals and the calculation of the distances, relative velocities and location angles of the located objects. In another embodiment of the present invention, however, it is also possible to outsource parts of the method to an external processor unit so that more processing capacity can be provided. For example, it is possible to carry out only the Fourier transformation in the distance dimension on the internal processor unit of the radar sensor and to carry out the other Fourier transformations as well as the reconstruction of the unambiguous spectrum and the object detection in the external processor unit.

If sufficient computing resources are available, a classic evaluation as described in the literature references cited above can be carried out as well in parallel with an improved evaluation according to the present invention and used as a second, algorithmically independent, path in the surroundings sensing. The classic evaluation and the improved evaluation can then optionally be implemented on different control devices. The classic evaluation can be implemented on the radar sensor, for instance, while the improved evaluation is implemented on an external processor unit.

Another possibility is to carry out the detailed processing according to the present invention only for those regions of the two-dimensional distance and velocity spectrum that are of particular interest in a given situation.

Embodiment examples of the present invention are explained in more detail in the following with reference to the figures.

### BRIEF DESCRIPTION OF THE DRAWINGS

FIG. 1 shows a block diagram of a FMCW radar sensor, according to an example embodiment of the present invention.

FIG. 2 shows a modulation pattern with two sequences of similar ramps transmitted with a time offset T12.

FIG. 3 shows antenna arrays for an angle-resolving radar sensor.

FIG. 4 shows a block diagram of an internal processor unit of a radar sensor and an external processor unit which together form a radar sensor system according to an example embodiment of the present invention.

FIG. 5 shows a schematic illustration of input data sets for a processing procedure in an example of the method according to the present invention.

FIG. 6 shows a flow chart of a method according to an example embodiment of the present invention.

### DETAILED DESCRIPTION OF EXAMPLE EMBODIMENTS

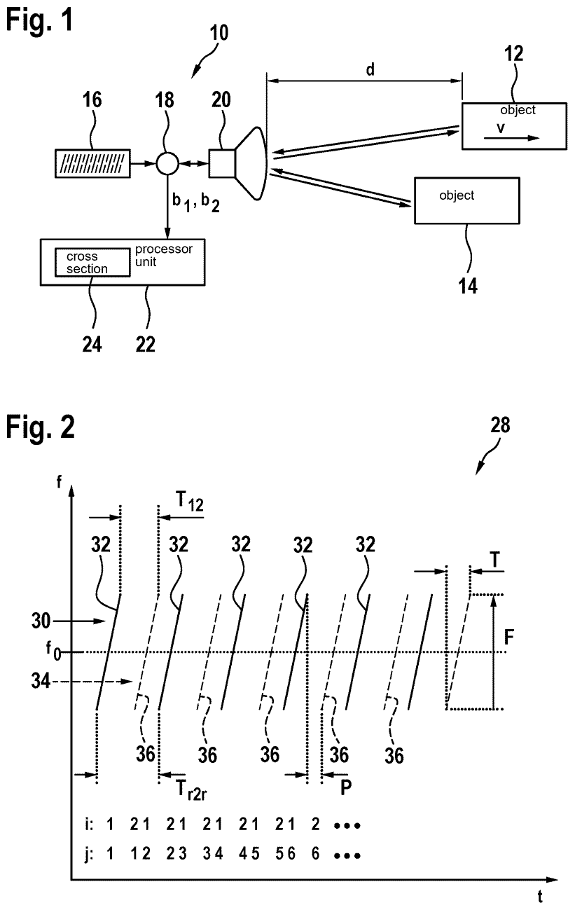

FIG. 1 shows a simplified block diagram of an FMCW radar sensor 10 that is installed at the front in a motor vehicle, for instance, and is used to measure distances d, relative velocities v and location angles of objects 12, 14, for example preceding vehicles. The radar sensor 10 comprises a voltage-controlled oscillator 16 that supplies a frequency-modulated transmission signal via a mixer 18 to a transmitting and receiving device 20 from which the signal is transmitted in the direction of the objects 12, 14. The signal reflected at the objects is received by the transmitting and receiving device 20 and mixed in the mixer 18 with a portion of the transmission signal. This results in a baseband signal b₁, b₂ that is digitized and further evaluated in a processor unit 22. The processor unit 22 includes a control section 24 that controls the function of the oscillator 16. The frequency of the transmission signal supplied by the oscillator is modulated within a radar measurement with sequences of rising or falling ramps.

FIG. 2 shows the transmission frequency f of the transmission signal 28 plotted over the time t. During a measurement, two sequences of ramps that have identical ramp parameters and are temporally interleaved are transmitted with a transmit antenna. A first sequence 30 of ramps 32 is shown in FIG. 2 with solid lines, while a second sequence 34 of ramps 36 is shown with dashed lines. The number i of the sequence to which a ramp belongs and the respective ramp index j of the ramp within a sequence are indicated.

The ramps 36 of the second sequence 34 are each shifted relative to the ramps 32 of the first sequence 30 having the same ramp index j by a time offset T12. Within each sequence 30, 34, the successive ramps 32 or 36 are shifted relative to one another by a temporal spacing Tr2r. The temporal spacing Tr2r is therefore the same for the two sequences. There is also a pause P between each two successive ramps of a sequence.

In the example shown in FIG. 2, the difference in the ramp center frequencies of successive ramps 32 or 36 within a sequence 30, 34 is equal to zero. All of the ramps therefore have the same frequency profile.

In the baseband signal b₁, b₂, portions b₁ that originate from the ramps 32 of the first sequence 30 alternate with portions b₂ that originate from the ramps 36 of the sequence 34. Because of the time offset T12 between the ramps 32 and 36, the portions b₁ and b₂ exhibit a relative phase shift which, for each located object, depends on the relative velocity of the object in question. This phase offset can be calculated and makes it possible to resolve ambiguities that arise due to undersampling in the Doppler dimension.

In the simplified example of FIG. 1, only two interleaved ramp sequences 30 and 34 are provided. In practice, however, the number of interleaved frequency ramps can be significantly greater so that ambiguities can be resolved more accurately or a greater degree of undersampling can be tolerated.

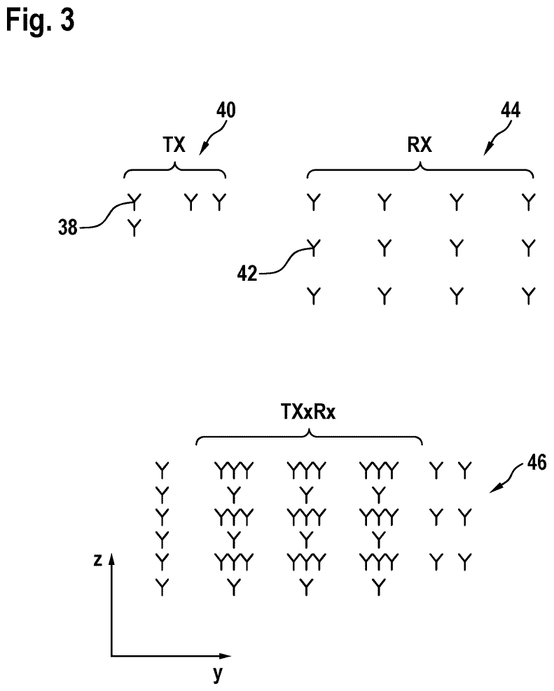

FIG. 3 schematically shows an antenna array of the transmitting and receiving device 20. A plurality of transmitting antennas 38 form a transmitter array 40 (TX), and a plurality of receiving antennas 42 form a receiver array 44 (RX). In the example shown, both arrays are two-dimensional, so that MIMO angle measurements are possible in both azimuth and elevation.

In the receiver array 44, the receiving antennas 42 are spaced at equal intervals in an angular resolution direction y, e.g. in the direction of the azimuth. The distances between the individual receiving antennas are so large that a large aperture and a correspondingly high angular resolution can be achieved with just a few antennas. However, the distances from antenna to antenna are greater than half the wavelength of the radar radiation, so that the Nyquist criterion is not met.

In the example shown here, the receiving antennas 42 are also spaced at equal intervals in elevation (in the angular resolution direction z), and, in this direction too, the antenna spacing is so large that non-unambiguous undersampling takes place.

The transmitting antennas 38 of the transmitter array 44 are spaced at unequal intervals in azimuth, but the distances are selected such that an unambiguous angle measurement is possible. The aperture is significantly smaller than in the receiver array 44, however, so that the angular resolution is lower. In elevation as well, the transmitter array 40 is designed with a smaller aperture for unambiguous angle measurements.

FIG. 3 also shows a synthetic array 46, which is obtained by combining each of the receiving antennas 42 with each of the transmitting antennas 38, so that the transit time differences of the signals from the transmitting antennas to the object and from the object to the receiving antennas add up. Ultimately, it is the aperture of this virtual array 46 that determines the resolving power of the radar sensor. It is necessary, however, to separate the signal portions in the reception signal originating from the various transmitting antennas 38 from one another so that the ambiguity of the receiver array can be resolved. This signal separation can be achieved in the conventional manner by time-division multiplexing, frequency-division multiplexing or code-division multiplexing.

In the example shown in FIG. 3, the two angular resolution directions y and z are furthermore decoupled from one another in the receiver array 38, because, for each y position of the receiving antennas, all of the z positions are also occupied by receiving antennas. The transmitter array 40, on the other hand, is an example of a non-decoupled array in which not all of the z positions are occupied for some of the y positions (the two positions on the right in FIG. 3). In general, a decoupled array facilitates data evaluation, whereas a non-decoupled array requires fewer antenna elements. The decision between decoupled and non-decoupled arrays can be made differently for the transmitting side and for the receiving side depending on the respective requirements.

The equidistant arrangement of the antenna elements (in azimuth and/or elevation) likewise facilitates the evaluation of the data, because it enables the use of a Fast Fourier Transform (FFT), for example. The non-equidistant arrangement of the antennas, as here for the transmitting antennas 38, on the other hand, has the advantage that the unambiguous angular range can be optimized for a given aperture.

In general, all combinations of equidistant and non-equidistant arrangement and decoupled or non-decoupled arrangement are possible for the radar system described here. Embodiments, in which the transmitter array is designed for ambiguous high-resolution angle measurements, while the receiver array is designed for unambiguous angle measurements with lower angular resolution, are possible too.

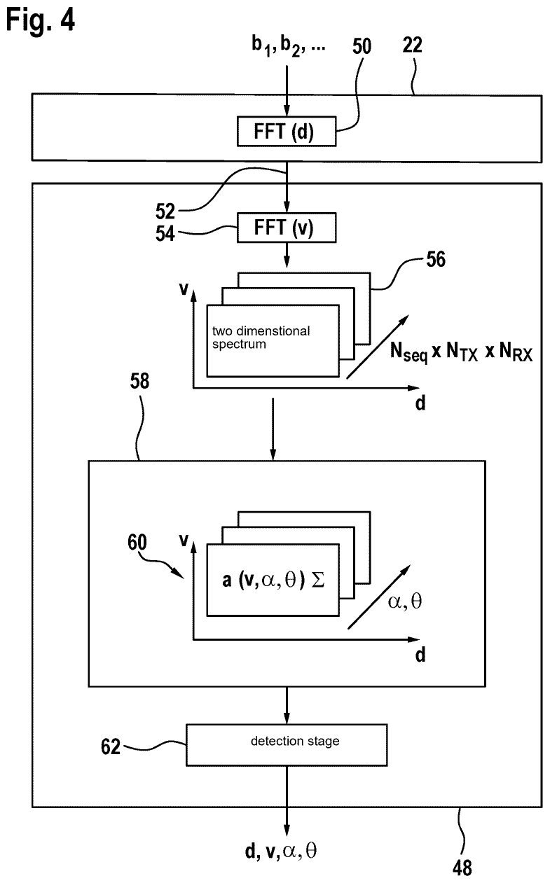

FIG. 4 shows a block diagram of the processor unit 22 of the radar sensor shown in FIG. 1 and an external processor unit 48 which is used to further process the signals preprocessed in the processor unit 22 of the radar sensor.

In the internal processor unit 22, in a first transformation stage 50, a one-dimensional spectrum 52 is formed from the baseband signals bi and b₂, . . . , which are obtained from a single frequency ramp 32 or 36, by one-dimensional Fast Fourier Transformation (FFT). Each object located by the radar sensor appears in this spectrum as a signal peak at a frequency that indicates the distance d of the object in question. The digital data that represent the thus obtained spectra 52 are transmitted to the external processor unit 48 where they are processed further. In the external processor unit, the spectra 52 that originate from the ramps of the same ramp sequence 30 or 34 are subjected to a further Fourier transformation. The frequency axis of each one-dimensional spectrum 52 is divided into a plurality of distance cells, and the Fourier transform in the transformation stage 54 is carried out separately for each distance cell. The signals obtained from the successive ramps of a single sequence vary periodically with a frequency that is dependent on the relative velocity v of the respective located object. In this way, the transformation stage 54 provides a two-dimensional spectrum 56 having a distance dimension d and a velocity dimension or Doppler dimension v for each ramp sequence.

In a MIMO radar with the antenna array shown in FIG. 3, it is in principle possible for each one of the transmitting antennas 38 to be combined with each one of the receiving antennas 42. Each receiving antenna 32 provides an input signal for a receiving channel of the radar sensor. The evaluation of this signal depends on which of the transmitting antennas 38 was active on the frequency ramp in question. For a plurality of receiving antennas 42 which have different distances to the active transmitting antenna 38 in the (horizontal) angular resolution direction y, the signals have a phase offset that depends on the distance between the receiving antennas 42 in the direction y and on the azimuth angle α of the located object. The signals from receiving antennas 42 which have different distances to the active transmitting antenna 38 in the direction z similarly have a phase offset that depends on the distance between the receiving antennas in this direction and on the elevation angle θ of the located object.

If all combinations of transmitting and receiving antennas are used in the time-, frequency-, or code-division multiplexing, a different two-dimensional spectrum 56 is obtained for each of these combinations and for each of the ramp sequences 30 or 34. Thus, if N_{seg} is the number of ramp sequences 30, 34, N_{TX} is the number of transmitting antennas and NRx is the number of receiving antennas, the total number of spectra 56 that can be evaluated is N_{seg}×N_{TX}×N_{RX}. Each one of these spectra 56 in itself is ambiguous due to the undersampling in the velocity dimension v. However, if the information from the spectra 56 obtained for the N_{seg} of different frequency ramps is used, this ambiguity can be resolved. In principle, in this evaluation, the spectra obtained for the same ramp sequence but for different combinations of transmitting and receiving antennas are redundant, so that it would suffice to evaluate one of these sequences of spectra. The spectra obtained for different combinations of transmitting and receiving antennas can nonetheless be used to estimate the angle in azimuth and elevation. The spectra 56 can be ordered into two sequences, for instance, namely one in which the spectra are ordered by increasing distance between the transmitting and the receiving antenna in the direction y, and one in which the spectra are ordered by increasing distance in the direction z. The full set of the two sequences of two-dimensional spectra 56 then forms a four-dimensional spectrum.

Based on the phase differences in the spectra of each sequence, it is then possible to carry out an angle estimation in azimuth or in elevation using conventional methods. The spectra 56 that relate to the same combination of transmitting and receiving antenna but belong to different ramp sequences are in principle redundant in these angle estimations. If the antenna spacings form a uniform grid, as is the case for the receiving antennas 42 in FIG. 3, for example, the angle estimation can be carried out efficiently using Fast Fourier Transformation, so that four-dimensional spectra with the dimensions distance d, velocity v, azimuth angle α and elevation angle θ are obtained. Ambiguities can also occur if the antenna array is underpopulated, and then have to be resolved using conventional methods.

However, it has proven useful to combine the velocity ambiguity resolution (VAR) with the angle estimation (ANG). This is because, in particular when multiple radar objects are present at the same time, the aforementioned redundancy between the different groups of spectra is not complete. If two objects that have at least approximately the same distance and the same relative velocity are located at the same time, for example, peak overlap occurs in the two-dimensional spectra 56 that makes object separation and resolution of ambiguities more difficult. However, if the objects differ in terms of their azimuth angle and/or elevation angle, there is no peak overlap in the three- or four-dimensional spectrum that includes the angle information. Therefore, in most cases, a single-target model will suffice to resolve velocity and/or angular ambiguities, while the more complicated multi-target models are rarely needed.

In any case, using a common single-target or multi-target model to model both velocity- and angle-dependent phase offsets makes it possible to make more extensive use of the information in the large number of spectra 56 and reconstruct an “ideal”—unambiguous-four-dimensional spectrum. The information lost due to undersampling is at least partially recovered by the phase alignment between the spectra obtained for different frequency ramps and different antenna combinations.

A reconstruction stage 58 for reconstructing an unambiguous four-dimensional spectrum 60 by joint evaluation of the spectra 56 and combined resolution of the velocity and possibly the angular ambiguities using a common single-target or multi-target model for the velocity and angle-dependent phase shifts is therefore provided in the external processor unit 48, in which each signal peak uniquely indicates the distance d, the relative velocity v, the azimuth angle α and the elevation angle θ of the object in question.

A phase correction is applied to the spectral values in the unambiguous spectrum 60 using a correction function a (v, α, θ) for different combinations of relative velocity v, azimuth angle α and elevation angle θ, and the spectral values are coherently added over the dimensions v, α and θ. The coherent summation suppresses secondary maxima in the spectrum and increases the signal-to-noise ratio, so that object detection can be carried out with high sensitivity and selectivity in a detection stage 62. The processor unit 48 thus provides unambiguous values for the distance d, the relative velocity v, the azimuth angle α and the elevation angle θ for each object detected with high sensitivity.

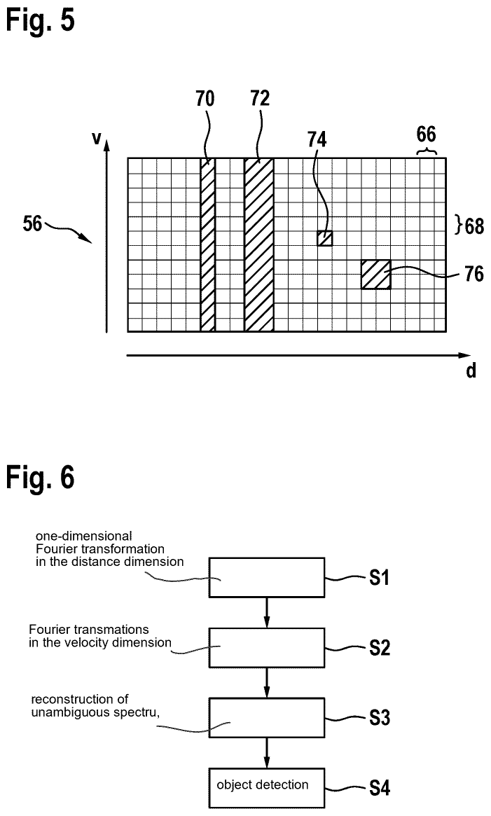

Different data structures can be used for the processing in the reconstruction stage 58, which will be discussed with reference to FIG. 5. This figure shows a single two-dimensional (ambiguous) spectrum 56 that is divided into distance cells 66 in the distance dimension d and into Doppler cells 68 in the Doppler or velocity dimension v.

In one embodiment, the input data for the reconstruction stage 58 form a data structure 70, which will be referred to as a “range gate”. This data structure includes the spectral values of all spectra 56 that belong to a single distance cell 66. This data structure thus includes the spectral values for all Doppler cells in the spectra 56 for all ramp sequences and all combinations of transmitting and receiving antennas.

In another embodiment, the data structure 72 of the input data is a group of several adjacent range gates, so that variations of the spectral values in the distance dimension can also be taken into account in the evaluation the data.

In a further embodiment, the input data form a data structure 74 that consists of a single distance and Doppler cell in all of the spectra 56 for the various ramp sequences and antenna combinations. The input data can optionally also be a “patch” 76 that includes several adjacent distance and Doppler cells.

In any case, the input data is converted into the reconstructed distance-Doppler azimuth and elevation spectrum 60 for the relevant range gate or the distance and Doppler cells of the relevant data structure 72, 74 or 76 using an algorithm based on the common single-target or multi-target model.

FIG. 6 once more summarizes the essential steps of the method. The method then comprises the following steps:
S1 one-dimensional Fourier Transformation in the distance dimension in the transformation stage 50
S2 Fourier Transformations in the velocity dimension in the transformation stage 54 to form the ambiguous spectra 56
S3 reconstruction of the unambiguous spectrum 60 without undersampling and phase correction and coherent summation of all distance-velocity subspectra in the reconstruction stage 58
S4 object detection based on the sum spectrum in the detection stage 62.

1-12. (canceled)

13. A method for detecting an object using an angle-resolving FMCW radar sensor, the method comprising the following steps:
generating an at least three-dimensional spectrum with a distance dimension, a Doppler dimension indicating a relative velocity of objects, and an angular dimension, based on received signals from multiple different receiving channels of the radar sensor, wherein the radar sensor undersamples in the Doppler dimension and the spectrum in the Doppler dimension is therefore incomplete and ambiguous;
using a frequency modulation scheme with a plurality of interleaved sequences of temporally equidistant frequency ramps to resolve the ambiguities;
for each of a plurality of velocity hypotheses, (i) modeling a velocity-dependent phase offset between the received signals obtained for the different sequences based on of known time offsets between the frequency ramps belonging to different sequences, and (ii) comparing the modeled phase offset with the measured phase offset;
during the comparison, evaluating angle-dependent phase offsets of the different receiving channels together with the velocity-dependent phase offsets and reconstructing a complete and unambiguous spectrum; and
carrying out the object detection based on the reconstructed spectrum.

14. The method according to claim 13, wherein the reconstruction of the unambiguous spectrum is carried out using a resolution of velocity ambiguities combined with an angle estimation based on a common single or multi-target model for velocity and angular dependence of phases.

15. The method according to claim 13, wherein the reconstruction of the unambiguous spectrum is carried out using a sparse reconstruction algorithm or a neural network.

16. The method according to claim 15, wherein training data are generated using simulation algorithms.

17. (New The method according to claim 13, wherein undersampling also takes place in at least one angular dimension and angular ambiguities are resolved in the reconstruction of the unambiguous spectrum.

18. The method according to claim 13, wherein input data for the reconstruction of the unambiguous spectrum form a multidimensional data structure containing spectral values of the at least three-dimensional ambiguous spectrum for at least one distance Doppler cell.

19. The method according to claim 18, wherein the data structure includes spectral values for all Doppler cells in at least one distance cell.

20. The method according to claim 13, wherein a combined velocity and angular beamforming algorithm is used in the resolution of the ambiguities.

21. The method according to claim 13, wherein the spectral values of the unambiguous spectrum are phase-corrected and coherently added over the Doppler dimension to provide a coherent sum and at least one angular dimension and object detection is carried out based on the coherent sum.

22. A radar sensor, comprising:
a digital processor unit configured for detecting an object using an angle-resolving FMCW radar sensor, the digital processor unit configured to:
generate an at least three-dimensional spectrum with a distance dimension, a Doppler dimension indicating a relative velocity of objects, and an angular dimension, based on received signals from multiple different receiving channels of the radar sensor, wherein the radar sensor undersamples in the Doppler dimension and the spectrum in the Doppler dimension is therefore incomplete and ambiguous,
use a frequency modulation scheme with a plurality of interleaved sequences of temporally equidistant frequency ramps to resolve the ambiguities,
for each of a plurality of velocity hypotheses, (i) model a velocity-dependent phase offset between the received signals obtained for the different sequences based on of known time offsets between the frequency ramps belonging to different sequences, and (ii) compare the modeled phase offset with the measured phase offset,
during the comparison, evaluate angle-dependent phase offsets of the different receiving channels together with the velocity-dependent phase offsets and reconstructing a complete and unambiguous spectrum, and
carry out the object detection based on the reconstructed spectrum.

23. A radar sensor system, comprising:
an angle-resolving FMCW radar sensor including an internal processor unit; and
an external processor unit;
wherein the radar sensor system is configured to implement, partly in the internal processor unit and partly in the external processor unit, a method for detecting an object using the angle-resolving FMCW radar sensor, the method including:
generating an at least three-dimensional spectrum with a distance dimension, a Doppler dimension indicating a relative velocity of objects, and an angular dimension, based on received signals from multiple different receiving channels of the radar sensor, wherein the radar sensor undersamples in the Doppler dimension and the spectrum in the Doppler dimension is therefore incomplete and ambiguous,
using a frequency modulation scheme with a plurality of interleaved sequences of temporally equidistant frequency ramps to resolve the ambiguities,
for each of a plurality of velocity hypotheses, (i) modeling a velocity-dependent phase offset between the received signals obtained for the different sequences based on of known time offsets between the frequency ramps belonging to different sequences, and (ii) comparing the modeled phase offset with the measured phase offset,
during the comparison, evaluating angle-dependent phase offsets of the different receiving channels together with the velocity-dependent phase offsets and reconstructing a complete and unambiguous spectrum, and
carrying out the object detection based on the reconstructed spectrum.

24. A radar sensor system, comprising:
an angle-resolving FMCW radar sensor; and
an external processor unit;
wherein the radar sensor system is configured to implement in the external processor unit, a method for detecting an object using the angle-resolving FMCW radar sensor, the method comprising:
generating an at least three-dimensional spectrum with a distance dimension, a Doppler dimension indicating a relative velocity of objects, and an angular dimension, based on received signals from multiple different receiving channels of the radar sensor, wherein the radar sensor undersamples in the Doppler dimension and the spectrum in the Doppler dimension is therefore incomplete and ambiguous,
using a frequency modulation scheme with a plurality of interleaved sequences of temporally equidistant frequency ramps to resolve the ambiguities,
for each of a plurality of velocity hypotheses, (i) modeling a velocity-dependent phase offset between the received signals obtained for the different sequences based on of known time offsets between the frequency ramps belonging to different sequences, and (ii) comparing the modeled phase offset with the measured phase offset,
during the comparison, evaluating angle-dependent phase offsets of the different receiving channels together with the velocity-dependent phase offsets and reconstructing a complete and unambiguous spectrum, and
carrying out the object detection based on the reconstructed spectrum.
